(19) United States
(12) Patent Application Publication
(10) Pub. No.: US 2006/0172075 A1
(43) Pub. Date: Aug. 3, 2006

(54) Method and compound for noise reduction in a vehicle

(76) Inventors: Takayuki Nagai, Toyota-shi (JP); Fumio Kawase, Aichi-ken (JP); Akira Tomoda, Nagoya-shi (JP)

Correspondence Address: GIFFORD, KRASS, GROH, SPRINKLE & CITKOWSKI, P.C, PO BOX 7021, TROY, MI, 48007-7021, US

(21) Appl. No.: 11/045,242

(22) Filed: Jan. 28, 2005

(51) Int. Cl. B05D 1/02

(52) U.S. Cl. 427/427.4; 427/421.1; 427/427.5

(57) ABSTRACT

The invention is a compound and method of application for damming vibrations and reducing noise panels of a vehicle. The compound is viscoelastic and includes synthetic rubber and calcium carbonate. The material may be glued to the inner surface of the vehicle or formed into a piece sprayed on the interior surface.

### FIELD OF THE INVENTION

The invention relates to a compound and method of use of the compound for reduction of noise in a vehicle. In particular, the invention relates to a compound which is applied to the interior of a panel of an automobile to reduce noise.

### BACKGROUND OF THE INVENTION

It is currently known as disclosed in Japanese Publication No. 06-246878 published Sep. 6, 1994 to attach a sheet of synthetic material to the interior panel of a vehicle such as a door to dampen vibration and reduce noise. The Japanese publication discloses the use of a sheet having polybutane within the interior of the door. It is also known to use sheets of material containing butyl rubber which are attached to the door by an adhesive such as mastic. However, application of such materials by adhesive and the like is labor intensive. Additionally, it would be advantageous to provide a material which would improve the level of noise reduction and which could be easily applied to the body.

### SUMMARY OF THE INVENTION

The invention relates to a synthetic compound consisting of a synthetic rubber and calcium carbonate and process oil which may be applied to internal surfaces of a vehicle. The material may be applied as a sheet which is fixed with an adhesive or alternatively may be formed into a paste which may be sprayed onto the interior surface of the vehicle.

### BRIEF DESCRIPTION OF THE DRAWINGS

A better understanding of the present invention will be had upon reference to the following detailed description when read in conjunction with the accompanying drawings in which like parts are given like reference numerals and wherein:

FIG. 1 is a partial cutaway side view of a vehicle shown from the inside with a noise reduction compound applied to the sheet metal in accordance with the invention; and

FIG. 2 is a sectional view of a sheet metal door panel taken along lines 2-2 of FIG. 1 in accordance with the invention.

### DETAILED DESCRIPTION OF THE INVENTION

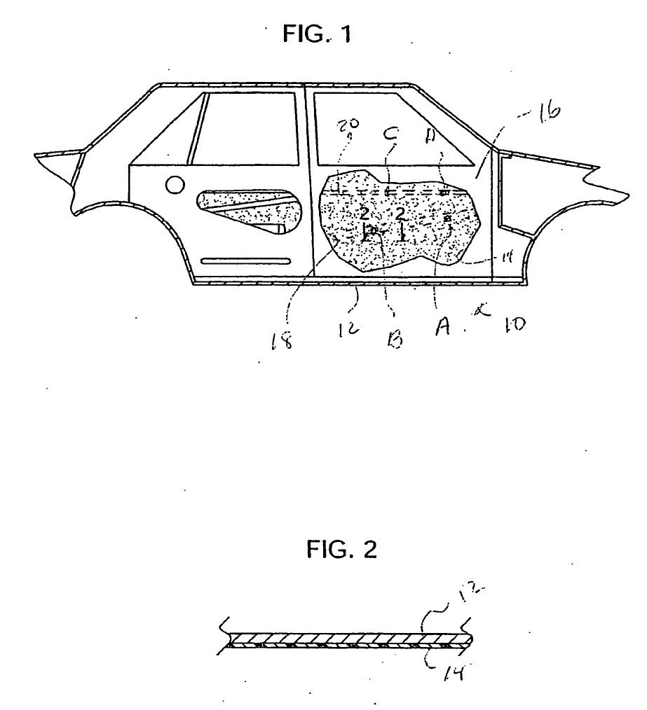

The present invention provides a novel viscoelastic compound and method of application for vibration and noise dampening in a vehicle 10. As shown in FIGS. 1 and 2, the compound 12 is applied to the interior surface 14 of a door panel 16 of the vehicle 10. Although shown in respect to the interior surface 14 of a door panel 16, the vibration dampening compound may be applied to any metal panel such as a trunk lid. In the preferred embodiment, the compound 12 is formed into a paste and sprayed onto the interior surface of the panel. Alternatively, the material may be formed into sheets and affixed to the door panel with an adhesive such as material as known in the art.

The material of the compound 12 is produced by Iida Sangyo of Japan. The compound 10 is composed as set forth in the following table:

TABLE 1

| Ingredient | Wt % |
|---|---|
| Synthetic rubber | 32.0 |
| Process oil | 25.0 |
| CaCO₃ | 24.2 |
| Paraffin wax | 8.0 |
| Vulcanization agent | 5.8 |
| Expansion agent | 5.0 |

The compound 12 applied in this form may be a solid sheet-type material. However, by use of an expansion material such as ADCA, the compound is expanded from 3-30 times and preferably 20-30 times. By adding (quantity) the compound is formed into a paste which may be sprayed directly to the sheet metal of the vehicle before the ED coat. The material has a visco-elasticity characteristic so that the energy of vibration is changed to heat and released. As shown in the tables 2, 3, 4 and 5 the compound has improved noise and vibration dampening with conventional material. Conventional material tables 2, 3, 4 and 5 provide a comparison of the vibration dampening of a conventional asphalt sheet with the compound of the invention taken at points A, B, C and D on the door panel as shown in FIG. 1 using a hammer test. Points A and B are located on an impact beam 18 and points C and D are located on a reinforcement member 20. As shown in these tables, noise reduction is improved.

From the foregoing, it can be seen that the above embodiments provide an improved viscoelastic compound 12 for vibration and noise reduction in a vehicle 10. The viscoelastic compound is lighter in weight and easier to apply than previously known materials. Having described the invention, however, modifications thereto may become apparent to those skilled in the art to which it pertains without deviation from the spirit of the invention as defined by the scope of the appended claims.

TABLE 2

| | | Visco Elastic |
|---|---|---|
| dB | Asphalt H2 | Compound H2 |
| 200 | 50 | 68 |
| 400 | 71 | 79 |
| 600 | 78 | 92 |
| 800 | 85 | 100 |
| 1000 | 92 | 105 |
| 1200 | 94 | 96 |
| 1400 | 103 | 110 |
| 1600 | 112 | 112 |
| 1800 | 113 | 114 |
| 2000 | 111 | 111 |

TABLE 4

| | | Visco Elastic |
|---|---|---|
| dB | Asphalt H2 | Compound H2 |
| 200 | 68 | 68 |
| 400 | 79 | 84 |
| 600 | 88 | 92 |
| 800 | 92 | 101 |
| 1000 | 100 | 108 |
| 1200 | 102 | 111 |
| 1400 | 105 | 113 |
| 1600 | 107 | 110 |
| 1800 | 112 | 112 |
| 2000 | 113 | 113 |

TABLE 3

| | | Visco Elastic |
|---|---|---|
| dB | Asphalt H2 | Compound H2 |
| 200 | 55 | 72 |
| 400 | 65 | 75 |
| 600 | 75 | 88 |
| 800 | 82 | 91 |
| 1000 | 92 | 97 |
| 1200 | 93 | 98 |
| 1400 | 101 | 104 |
| 1600 | 101 | 110 |
| 1800 | 100 | 102 |
| 2000 | 110 | 110 |

TABLE 5

| | | Visco Elastic |
|---|---|---|
| dB | Asphalt H2 | Compound H2 |
| 200 | 79 | 79 |
| 400 | 80 | 81 |
| 600 | 80 | 92 |
| 800 | 90 | 101 |
| 1000 | 100 | 106 |
| 1200 | 106 | 107 |
| 1400 | 107 | 107 |
| 1600 | 105 | 110 |
| 1800 | 111 | 112 |
| 2000 | 116 | 116 |

I claim:

1. A compound for reducing noise in a motor vehicle, the motor vehicle having a body formed of sheet metal, the sheet metal having an exterior surface and an interior surface, the compound applied to the interior surface of the sheet metal, the compound comprising:
In the range of a synthetic rubber in the range of 30-35% by weight and calcium carbonate 20-30%, and process oil 20-30% by weight.

2. The compound of claim 1, wherein the compound includes an expansion material to form a paste.

3. A method of reducing noise in a vehicle having a body formed of sheet metal, said method comprising the steps of:
forming a viscoelastic compound having synthetic rubber and calcium carbonate; and
applying the compound to an interior surface of the sheet metal.

4. The method of claim 3, wherein the compound is applied by spraying.
